(19) United States
(12) Patent Application Publication
(10) Pub. No.: US 2011/0013339 A1
(43) Pub. Date: Jan. 20, 2011

(54) ASSEMBLY OF MAGNETIC CAPACITOR WITH PACKAGING

(76) Inventors: Chung Ping Lai, Hsinchu Hsien (TW); James-Chyi Lai, Taipei (TW); Chwei-Jing Yeh, Hsinchu Hsien (TW); Wei- Kong Liu, Hsinchu City (TW); Wen-Hsin Peng, Hsinchu City (TW); Ching-Yu Lu, Taipei Hsien (TW)

Correspondence Address: Chung-Ping Lai, 235 Chung - Ho, Box 8-24, Taipei, 235, TW

(21) Appl. No.: 12/503,076

(22) Filed: Jul. 15, 2009

(51) Int. Cl. H01G 4/008

(52) U.S. Cl. 361/305

(57) ABSTRACT

An assembly of an magnetic capacitor with a packaging comprises: a magnetic capacitor; two packing electrodes, one of the two end electrodes including an upper magnetic casing installed upon a top surface of the capacitor and a lower magnetic casing installed at a lower surface of the capacitor; each of the upper magnetic casing and the lower magnetic casing being formed with extruding pieces which is arranged around a lateral side of the capacitor; and at least one insulation material for isolating magnetic material is arranged within the magnetic capacitor.

### BACKGROUND OF THE INVENTION

1. Field of the Invention

The present invention relates generally to packaging of the energy storage devices, and in particularly relates to a capacitor, a battery and a method of packaging of these devices.

2. Description of the Related Art

Capacitors are widely used in all electronics for storage of electric energy. These devices are very reliable with nearly unlimited charge and discharge lifetime. Therefore, capacitor technology attracts attentions of battery market to convert this reliable device into an energy storage device. With the discovery of Colossal magnetic effect, the capacitance of a regular capacitor can be magnified in several orders of magnitude when the electrical storage area experienced strong magnetic field. The magnetic boosting of capacitance is so dramatic so that applications of magnetic capacitors to store ultrahigh electrical energy and replace conventionally available battery become feasible. Nevertheless, magnetic field is strongly subject to the magnet design and geometry. Any open air gap will result in magnetic flux divergence or increase the reluctance in the magnetic circuit because the ability of air or non-magnetic materials to conduct the magnetic flux is much lower than a magnetic material. The loss of magnetic flux will result in the low remaining magnetic strength of the magnetic capacitors and lower the magnification of capacitance. Since the design of a thin capacitance cannot avoid the air gap, it is the aim of this invention to present methods to increase the magnetic flux density and increase the storage capacity of the capacitor.

### SUMMARY OF THE INVENTION

It is, therefore, the objectives of the present invention to provide a novel method to package the said magnetic capacitor.

Another objective of the present invention is to provide a method to increase the remaining magnetic strength of the magnetic layer used in the said magnetic capacitor.

Another objective of the present invention is to provide a method to increase the capacitance of the magnetic capacitor via increase the magnetic flux density of the magnetic layers inside the said magnetic capacitor since the capacitance is directly related to the magnetic field experienced by the dielectric materials inside the capacitor.

Another objective of the present invention is to provide a packaging method of a magnetic capacitor in which the packaging is composed of magnetic and electric conducting characteristics. The magnetic and electric conducting performance of the packaging can be done by a monolithic structure or by various combinations to form a composite structure. This composite structure leads to the functions needed by the packaging of the present invention.

Another objective of the present invention is to provide a method to packaging the said magnetic capacitor with a robust mechanical house to withstand the regular usage in all possible applications.

To achieve above object, the present invention provides an assembly of a magnetic capacitor with a packaging, comprising: a magnetic capacitor; two packing electrodes, one of said two end electrodes including an upper magnetic casing installed upon a top surface of the capacitor and a lower magnetic casing installed at a lower surface of the capacitor; each of the upper magnetic casing and the lower magnetic casing being formed with extruding pieces which is arranged around a lateral side of the capacitor; and at least one an insulation material for isolating magnetic material within the magnetic capacitor.

### BRIEF DESCRIPTION OF THE DRAWINGS

These and other features, aspects, arrangements and advantages of the present I Invention will be understood better with regard to the following description, appended claims and accompanying drawings where:

FIG. 1 is a cross sectional view showing a configuration of a packaging of embodiment of the present invention;

FIGS. 3A and 3B are a cross sectional view showing a typical magnetic arrangement of a vertically aligned magnetic capacitor

FIG. 3C is a cross sectional view showing a typical magnetic arrangement of a horizontally aligned magnetic capacitor

FIG. 4 is a cross sectional view showing an example of series connection of the magnetic capacitor using the packaging method of present invention; and

FIG. 5 is a cross sectional view showing an example of stacking of the magnetic capacitor using the packaging method of present invention.

### DESCRIPTION OF THE PREFERRED EMBODIMENTS

The present invention will be described and explained in details with reference to its embodiments. Examples of the embodiments are illustrated in the accompanying diagrams. All diagrams are drawn for the ease of understanding and explanation of present invention only; the extensions of the drawing with respect to number, ratio, position, relationship, dimension of the parts to form the embodiment will be explained or will be within the skill of the art after the following description has been read and understood.

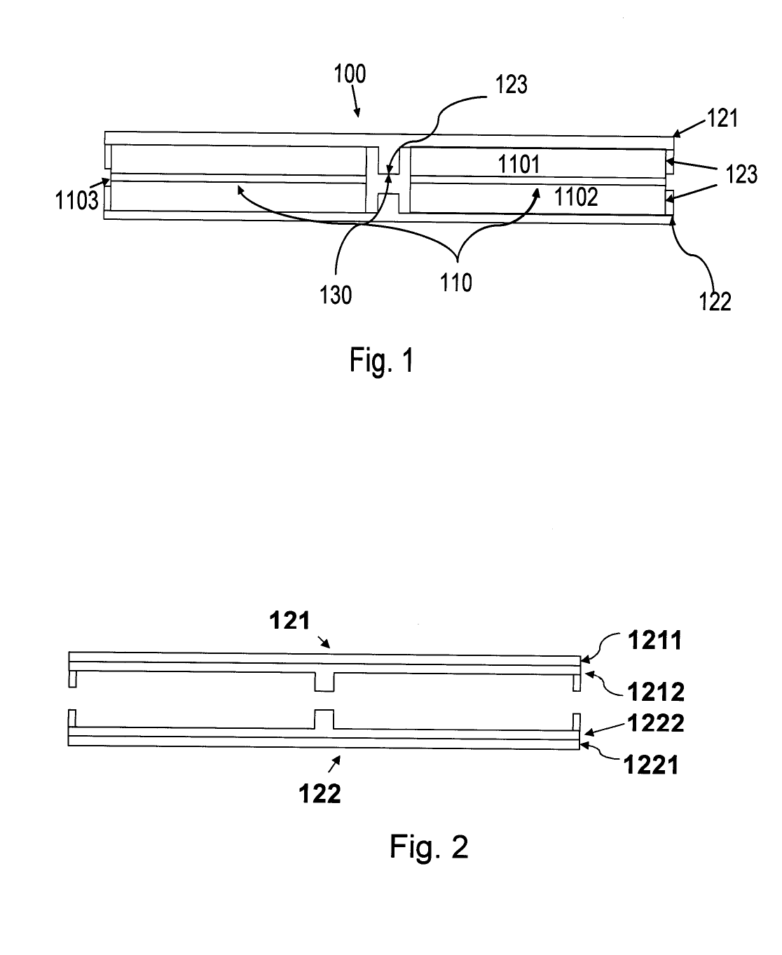

FIG. 1 shows a configuration of a packaging method of the present invention; a assembly of an illustrative magnetic capacitor with packaging(100) according to the present invention, comprises: a magnetic capacitor (110); and two packing magnetic casing (121, 122), one of the two magnetic casing including an upper magnetic casing (121) exposed on both the top and bottom surfaces of the capacitor and the other one of said two magnetic casings includes a lower magnetic casing (122) exposed on both the top and bottom surfaces of the said magnetic capacitor. Two of the aforementioned packing magnetic casings may be made in the geometry which consists of extruding pieces (123). To avoid electric conduction, an insulation material (130) is used in the packaging which electrically separates the upper and lower packaging materials. This isolation material can be made of a magnetic or non-magnetic material.

It should be noted that each of the magnetic casings (121, 122) is made of a monolithic magnetic material which is electrically conductive to the

The magnetic capacitor (110) is formed by three layers. Two magnet layers 1101, 1102 are installed at an upper side and a lower side thereof An dielectric layer 1103 are installed between the two magnetic layers 1101, 1102 so as to form as a capacitor for electric power storage.

In FIG. 2, it further illustrates that the upper magnetic casing (121) is formed by two layers which includes an upper magnetic layer (1211) and an upper magnetic pole sheet (1212) below the upper magnetic layer (1211) and at an upper side of the magnetic capacitor (110); the upper magnetic layer (1211) is made of magnetic materials which is not electrically conductive and the upper magnetic pole sheet (1212) is made of electrically conducting material. The lower magnetic layer (122) is formed by a lower magnetic layer (1221) and a lower magnetic pole sheet (1222) below the upper magnetic layer (1221) and at an upper side of the magnetic capacitor (110); the lower magnetic layer (1221) is made of magnetic materials which is not electrically conducting and the lower magnetic pole sheet (1221) is made of electrically conducting material.

By the packaging (100), the entire assembly of the packaging is arranged so the the magnetic capacitor is surrounded by the packaging. The leaking and fringing magnetic flux in the open end of the said magnetic capacitor is able to be limited by this packaging. Therefore, the air gap of the said magnetic capacitor is reduced and the remaining magnetization as well as capacitance of the said magnetic capacitor is increased.

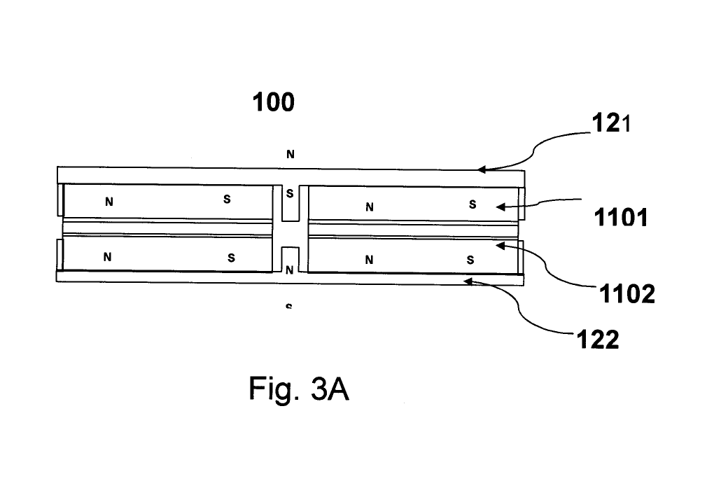

FIGS. 3A to 3C show examples of how magnetic field of packaging should be arranged for either vertically or horizontally aligned magnetic capacitors. The magnetic arrangement of the packaging will ensure the minimum leakage and fringing of the packed magnetic capacitors. To meet all possible applications, the magnetic capacitor can be made by various processes with the magnetic capacitor sized from diminutive to huge. A well known manufacturing method to produce diminutive magnetic capacitor can be made by conventional semiconductor process. This production method results in the total capacitance of the magnetic capacitor is contributed by numerous minute capacitors. Typically, all the magnetic capacitor units are magnetically annealed and magnetized in the macroscopic annealing apparatus. Therefore, the packaging method of the present invention can be applied to reduce the leaking and fringing magnetic field no matter size of the packaged capacitors is. In FIG. 3A, a direction of the polarities of the magnets 1101, 1102 of the capacitor are vertical to a direction of the polarities of the upper magnetic casing 121 and the lower magnetic casing 122. In FIGS. 3B and 3B, a direction of the he polarities of the magnets 1101, 1102 of the capacitor are parallel to a direction of the polarities of the upper magnetic casing 121 and the lower magnetic casing 122. In FIG. 3B, the polarity of the magnets 1101 is identical to that of the magnets 1102. In FIG. 3C, the polarity of the magnets 1101 is reverse to that of the magnets 1102.

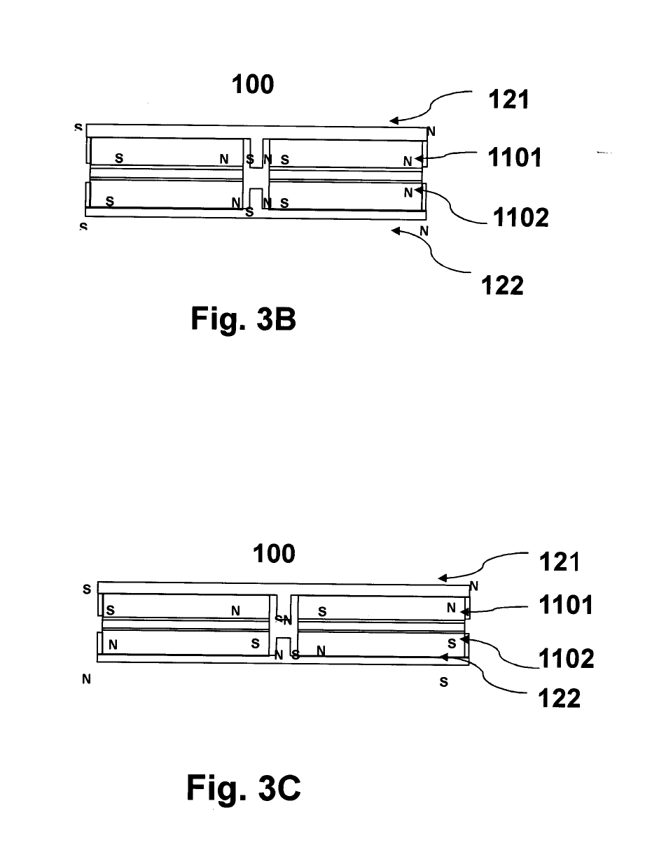

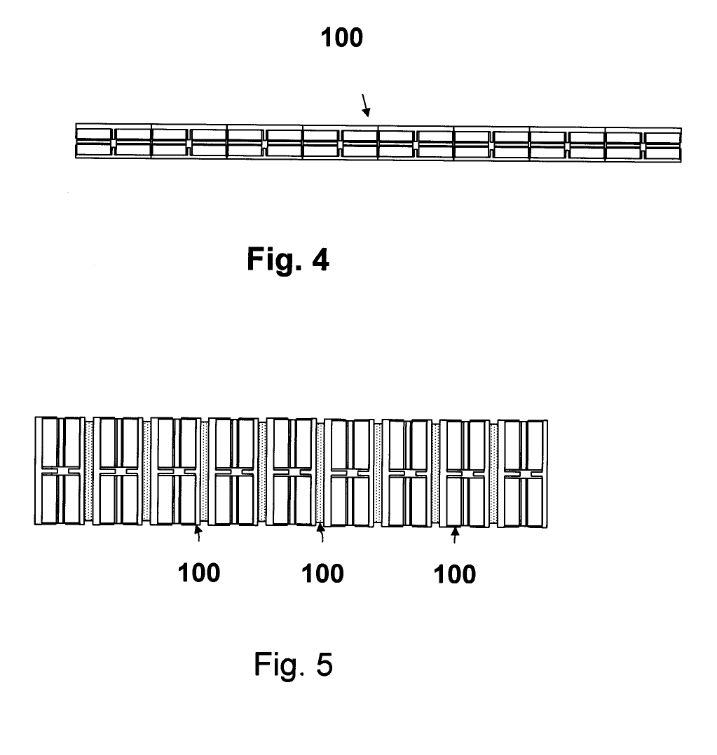

FIGS. 4 and 5 show the connecting method of packaged magnetic capacitors, where FIG. 4 is a cross sectional view showing an example of series connection of the magnetic capacitor using the packaging method of present invention; and FIG. 5 is a cross sectional view showing an example of stacking of the magnetic capacitor using the packaging method of present invention; despite the known arts of increasing voltage or capacitance by the connection of the capacitors in series (see FIG. 4) or in parallel (see FIG. 5), a side benefit of the present packaging is for self alignment and connection of the packaged magnetic capacitors in parallel. With the addition of electrical insulator, a stacking of packaged magnetic capacitors can be done with the help of leaking and fringing magnetic field emerging from packaging.

The present invention has been described with particular reference to certain preferred embodiments. It should be understood that the foregoing description and examples are only illustrative of the present invention. Various alternatives and modifications thereof can be devised by those skilled in the art without departing from the spirit and scope of the present invention. Accordingly, the present invention is intended to embrace all such alternatives, modifications, and variations that fall within the scope of the appended claims.

What is claimed is:

1. An assembly of an illustrative magnetic capacitor with a packaging (100), comprising:
a magnetic capacitor (110);
two packing magnetic casing, one of said two magnetic casing including an upper magnetic casing (121) installed upon a top surface of the capacitor and a lower magnetic casing (122) installed at a lower surface of the capacitor;
each of the upper magnetic casing (121) and the lower magnetic casing (122) being formed with extruding pieces (123) which is arranged around a lateral side of the capacitor (11); and
at least one insulation material (130) for isolating magnetic material within the magnetic capacitor.

2. The assembly according to claim 1, wherein each of said magnetic casing is made of a monolithic magnetic material which is electrically conductive to serve as end electrodes.

3. The assembly according to claim 1, wherein the upper magnetic casing (121) is formed by two layers including an upper magnetic layer (1211) and an upper magnetic pole sheet (1212) below the upper magnetic layer (1211) and arranged at an upper side of the magnetic capacitor (110); the upper magnetic layer (1211) is made of magnetic materials which is not electrically conductive and the upper magnetic pole sheet (1212) is made of electrically conductive material.

4. The assembly according to claim 1, wherein the lower magnetic layer (122) is formed by a lower magnetic layer (1221) and a lower magnetic pole sheet (1222) below the upper magnetic layer (1221) and at an upper side of the magnetic capacitor (110); the lower magnetic layer (1221) is made of magnetic materials which is not electrically conductive and the lower magnetic pole sheet (1221) is made of electrically conductive material.

5. The assembly according to claim 1, wherein the insulation material (130) is magnetic or non magnetic materials.

6. The assembly according to claim 1, wherein the magnetic casings (121 and 122) serve to conduct electricity current for either charging and/or discharging applications; and the packaging is in the electric contact with the magnetic capacitor underneath.

7. The assembly according to claim 1, wherein the magnetic casings (121 and 122) is magnetic block pieces to enhance magnetic flux density useful to increase the capacitance of a magnetic capacitor (110).

8. The assembly according to claim 1, wherein a direction of polarities of the magnets (1101, 1102) of the capacitor are vertical to a direction of polarities of the upper magnetic casing (121) and the lower magnetic casing (122).

9. The assembly according to claim 1, wherein a direction of polarities of the magnets (1101, 1102) of the capacitor are parallel to a direction of polarities of the upper magnetic casing (121) and the lower magnetic casing (122).
